(19) United States
(12) Patent Application Publication
(10) Pub. No.: US 2026/0300281 A1
(43) Pub. Date: Oct. 1, 2026

(54) DYNAMIC DATA SAMPLING

(71) Applicant: PAYPAL, INC., San Jose, CA (US)

(72) Inventor: Vishnu Surendran, Koppam (IN)

(21) Appl. No.: 19/096,484

(22) Filed: Mar. 31, 2025

(51) Int. Cl. G06F 16/245

(52) U.S. Cl. CPC G06F 16/245

(57) ABSTRACT

Dynamically sampling a large data set may include defining a plurality of data batches, sampling a uniform quantity of data points from each of the batches in a first sampling iteration, examining the initial data sample for the target information, calculating an initial target information score indicative of a degree of presence of target information included in the initial data sample, and iteratively individually examining the batches by selecting a batch, sampling a quantity of data points from the selected batch, examining the further data sample for the target information, calculating a further target information score indicative of a degree of presence of target information in the further data sample, and continuing the iterations until the further target information score is below a threshold.

### TECHNICAL FIELD

This disclosure relates to sampling of large data sets, including rapid sampling to accurately determine the content of a data set.

### BACKGROUND

Searching a data store to find target information can be a processing-intensive task, particular when the data store contains a large amount of data and/or when the data in the data store changes frequently. For example, an organization that collects large quantities of data from users—such as organizations that receive search queries, that process computing actions using backend infrastructure, and/or that receive user input to a chatbot or other service—may regularly monitor stored data to ensure that it complies with data retention policies. In addition, sampling data stores to determine likely locations for data responsive to a user search, before an exhaustive search of the relevant data store or data sets, may be performed.

### BRIEF DESCRIPTION OF THE DRAWINGS

FIG. 1 is a block diagram view of an example system for dynamic sampling of large data sets.

FIGS. 2, 3, and 4 are a block diagram views of an example storage scheme for a data store, illustrating an example relationship between a database, data tables, and data sets.

FIG. 5 is a flow chart illustrating an example method of batching a data set and sampling from multiple batches.

FIG. 6 is a flow chart illustrating an example method of batching a data set and sampling from individual batches.

FIG. 7 is a flow chart illustrating an example method of sampling data within a data store.

FIG. 8 is a flow chart illustrating an example method of dynamic sampling of a large data set.

FIG. 9 is a block diagram of an example computing system.

### DETAILED DESCRIPTION

Extracting a data sample from a huge data store is often very difficult, especially when the data is non uniform. Sampling according to a single predefined pattern, such as the first N data entries or the last N entries, etc., often does not give a good mix of the data. Purely random sampling can also be problematic due to its high processing requirement, and it also doesn't guarantee a good mix of samples. Any analysis performed on a sample that is not uniformly extracted often leads to unreliable findings, so getting a good sample data is paramount for any process.

One context in which sampling a large data set is important is identification of Personal Identifiable Information (PII). Scanning through a huge data store having millions of rows and identifying all PII in a computationally-efficient manner can be difficult, if not impossible. If the entire data store is first sampled to gain an understanding of the extent of stored PII in the store and to therefore classify the data store, a more efficient process can be pursued, as further search and extraction strategies can be customized based on the data store's contents and classification. As a result, accurate sampling of the data store is crucial for efficient monitoring and data retrieval for the data store.

The instant disclosure provides techniques for dynamic data sampling for computationally-efficient and yet accurate sampling of one or more data sets in one or more data stores. Dynamic data sampling according to the present disclosure may provide a data sample collected from a huge data store that is relevant and uniformly extracted with low possible processing time and low use of computing resources. Dynamic data sampling can be employed in a wide variety of scenarios where a sample data is extracted for any sort of analysis or other processing.

Dynamic data sampling may include dividing a data store into batches of dynamic count and size, and collecting random sampled from each batch to extract the data uniformly across the whole data store. Further data sampling and examination may be done iteratively to collect more and more samples if the data seems promising to have more new findings. The number of iterations of sample collection may be variable and dynamic, determined at run time for each data store based on the data. For example, a data store with more PII content would be sampled more times to extract and identify more (e.g., all) unique PII elements present in the store whereas a data store without much PII will be stopped scanning after very few rounds. This helps in making sure that the processing time and resource is allocated to data sets that warrant more sampling to find more data, rather than using unnecessary processing resources on large quantities of data that are not likely to include PII.

Dynamic data sampling may include batched sampling (e.g., random sampling), described above, and batch rankings. Ranking may include, after each sampling iteration, determining a degree of presence of target data in the sample, such as by application of a formula that accounts for both a quantity of target data and a classification of target data included in the sample. For example, a three-rank system may be utilized, where a rank is incremented or decremented based on the presence of target data in a batch, and where the rank reaching the lowest rank may terminate the sampling process.

Dynamic data sampling according to the present disclosure may have particular use in connection with enterprise-level data storage, where an enterprise may store data in millions of tables in a large number of data stores. Further, the data may be stored in different formats from table to table and/or store to store. Some data may be structured, other data may be unstructured.

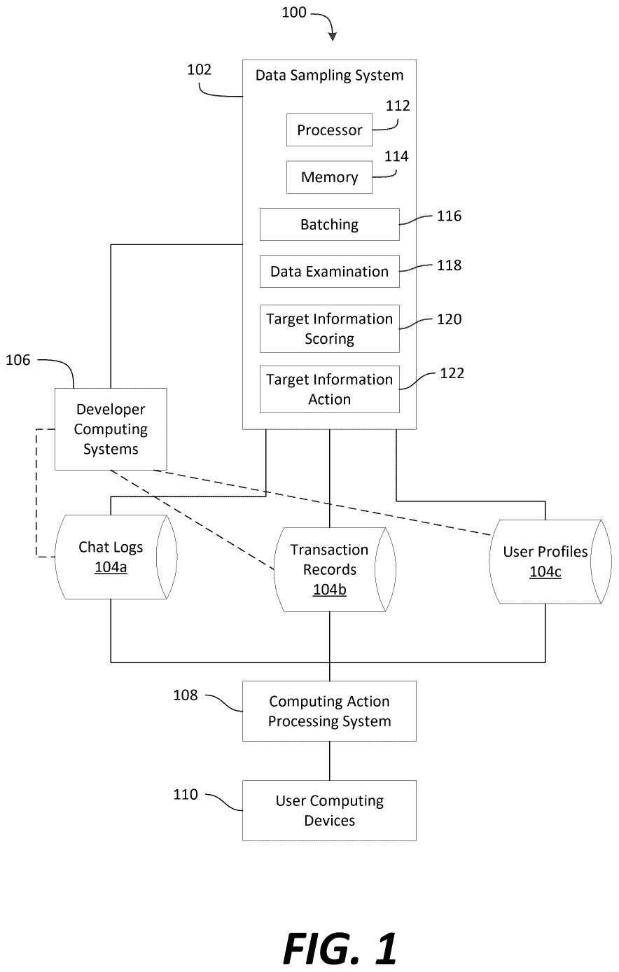

Referring to the drawings, wherein like numerals refer to the same or similar features in the various views, FIG. 1 is a block diagram view of an example system 100 that includes a data sampling system 102 for sampling one or more data stores (e.g., databases) 104 such as, for example, a store of chat logs 104a, a store of transaction records 104b, a store of user profiles 104c, and/or one or more other data stores. The system 100 may further include a plurality of developer computing systems 106, a computing action processing system 108, and a plurality of user computing devices 110.

In general, the computing action processing system 108 may be, may include, or may support a server that provides one or more user interfaces through which users may engage in computing actions through the user computing devices 110. The user interfaces may be or may include, for example, a website, mobile application, etc. Through the user interface, users may engage in computing actions such as file transfers, browsing item webpages and listings, communicating with other users, and the like. The various data stores may include data collected through the interfaces, and/or presented in the interfaces. For example, users may interact with a chatbot in the interface, and logs of chats may be stored in the chat logs 104a. Transactions and other computing actions made through the interface may be recorded in the transaction records 104b. Profiles for the users, as those users relate to the interface, may be stored in the user profiles 104c.

In many instances, data in the data stores 104 needs to be searched for specific information, or for specific types of information, such as PII. As noted above, when searching large quantities of data, it is often not efficient to exhaustively check every data entry. Accordingly, sampling one or more data stores to look for examples of particular information, or particular types of information, to determine which portions of a data store 104 to search on a more granular level, can improve overall efficiency of the interface and supporting systems, reduce the processing load on the computing action processing system 108 and other backend systems, and improve response times to users when users initiate such data searches.

The data sampling system 102 may include a processor 112 and a non-transitory, computer-readable memory 114 storing instructions that, when executed by the processor 112, cause the data sampling system 102 to perform one or more of the methods, operations, algorithms, etc. of this disclosure. The data sampling system 102 may include a plurality of functional modules 116, 118, 120, 122 that may be embodied in hardware and/or software. In some embodiments, one or more of the functional modules 116, 118, 120, 122 may be embodied as instructions in the memory 114.

The data sampling system 102 may include a batching module 116 that accesses one or more data sets (e.g., in one or more data stores 104) and separates those data sets into batches. In some embodiments, the batching module 116 may divide a single data set into a plurality of batches. In some embodiments, the batching module 116 may divide two or more data sets into a plurality of batches, in which a given batch may span more than one of the data sets. In some embodiments, the batching module 116 may generate batches of equal size (e.g., an equal quantity of data entries per batch). The batching module 116 may select data points from a data set to be included in a batch randomly, and/or according to a predetermined, non-random sampling strategy.

The batching module 116 may, in some embodiments, determine one or more appropriate data stores, tables, documents, files, graphs, etc. to batch based on the particular information or type of information that is sought. For example, where a search is directed to information related to a transaction for a particular file or file type, the batching module 116 may batch data sets from the transaction records 104b. In another example, where a search is for personally-identifiable information (PII), such as to ensure compliance of PII storage with applicable rules and regulations, the batching module 116 may search all available data stores 104a, 104b, 104c.

The data sampling system 102 may include a data examination module 118 that reviews data included in batches for target information. The data examination module 118 may receive an identification of particular target information, or a particular target type of information, and examine the sampled data for the target information. In some embodiments, the data examination module 118 may apply a machine learning model that is trained to recognize and classify target information. Such a model may receive, as input, one or more sampled items of data and may output one or more tags for the input data.

The data examination module 118 may tag, extract, and/or otherwise note sampled data responsive to a search. The responsive data may be utilized for further analysis in the sampling process, as described below, and may also be returned to the user or system that provided the search request or may be otherwise automatically acted upon by the data sampling system 102.

The data examination module 118 may assign a class label to each identified item of target information included in a sample, in some embodiments. For example, where target information is PII, the type of PII identified may be assigned a class depending on its potential to directly identify an individual, whether or not storage of the information requires policy compliance review, and/or based on other aspects. In another example, where target information is responsive to a substantive user search, a class may be assigned based on a likelihood that the information is responsive to the search. In yet another example, where target information is respective of a particular user (e.g., in order to compile a profile of the user), a class may be assigned based on the degree of likelihood of correspondence between the item of data and the user (e.g., where data associated with a name match may be a highest class, data associated with an IP address match is a next-highest class, data associated with a user geographic region is a lowest class, and so on). The data examination module 118 may assign a class label automatically, based on predefined rules, or by applying a relatively small classification model trained on domain data.

The data sampling system 102 may include a target information scoring module 120 that accesses the data identified as responsive by the data examination module 118. The target information scoring module 120 may determine a target information score based on a weighted quantity of target information in one or more data sets. For example, the target information scoring module 120 may determine a target information score according to a quantity of target information identified in a sample and/or a class of information identified in the sample.

In an example, the target information scoring module 120 may calculate a target information score for a given sample applying a weight (W_{Q}) (e.g., 0.2) to the quantity of target data and a weight W_{C} (e.g., 0.8) to the class(es) of target data.

First, a target data quantity score So may be calculated according to equation (1) below:

$${S}_{Q} = ( \frac{Q}{S} ) * 100 * {W}_{Q} \qquad ( Eq . 1 )$$

where Q is the quantity of target data identified in the sample and S is the total size of the sample.

Second, a target data class score Sc may be calculated according to equation (2) below:

$${S}_{C} = C * {W}_{C} \qquad ( Eq . 2 )$$

where C is a highest class score of the identified target data. For example, target data may be divided into multiple (e.g., a plurality of) ranked classes, with each class assigned a score. For example, class scores may be as set forth in Table 1 below:

TABLE 1

| Class | 1 | 2 | 3 | 4 | 5 |
|---|---|---|---|---|---|
| Score | 100 | 90 | 80 | 50 | 0 |

As noted above, out of all target data identified in a sample, the highest class only is considered, in some embodiments. For example, if class 1 data and class 3 data are identified, regardless of quantities of those classes in the sample, only class 1 is considered, and C is taken as the class 1 score.

In other embodiments, the class-based score may be calculated as a weighted or unweighted average of the quantities of each class of data identified in the sample. Still further class-based score formulations are possible.

Third, a total target information score S may be calculated according to equation 3 below:

$$S = {S}_{Q} + {S}_{C} \qquad ( Eq . 3 )$$

In some embodiments, the target information scoring module 120 may assign a rank to the sampled data based on the target information score for a current sample and a previous rank (e.g., a rank from a previous sampling and scoring iteration) for the data set. For example, the target information scoring module 120 may apply a three-rank arrangement (with ranks of 1, 2, and 3). When an initial sample is above the threshold, the data set may be assigned a rank of “1.” If a target information score drops below the threshold in a batch sample, the data set rank may be increased to “2.” If the next sample is also below the threshold, the rank may again be increased to “3.” If, however, the next sample is above the threshold, the rank may be returned to “1.” When the rank reaches “3,” the iterative sampling process may end.

The data sampling system 102 may further include a target information action module 122 that may automatically execute one or more actions on identified target information. For example, the target information action module may alter a data set, such as by deleting, encrypting, anonymizing, or otherwise altering one or more data entries in the data set. In another example, the target information action module 122 may automatically generate and return to a requesting user a summary of the identified target information, such as a quantity of identified target information entries, a percentage of data sets in one or more data stores that include identified target information, the locations of identified target information in one or more data stores (e.g., applicable tables, documents, etc.), and so on. In some embodiments, the target information action module 122 may return to a requesting user a list or other compilation of the identified target information. Still further, in some embodiments, the target information action module 122 may initiate a comprehensive search respective of one or more data sets (e.g., of one or more entire data stores) to identify all target information in that data set, such as where a quantity or percentage of target data identified via sampling was above a comprehensive search initiation threshold.

In some embodiments, after automated action by the target information action module 122, further action on one or more data sets may be taken by a user. For example, a user may initiate a comprehensive search of a data store for all data of a particular type.

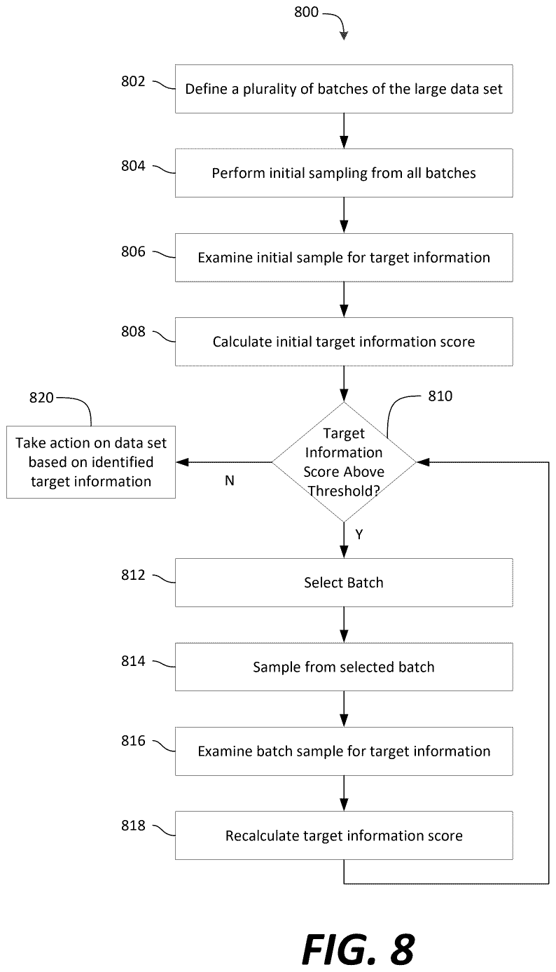

In some embodiments, the data sampling system 102 may perform a process—explained in greater detail with respect to FIG. 8 below—in which an initial sample is taken of a data set by the batching module 116, the initial sample is examined by the data examination module 118, and a score is calculated for the sample by the target information scoring module 120, and that score is compared to one or more thresholds to determine further processing. For example, if the score is below a threshold, the sampled data set may be determined not to include sufficient target information to warrant further examination. If the score is above the threshold, the sampled data set may be iteratively re-sampled for further analysis.

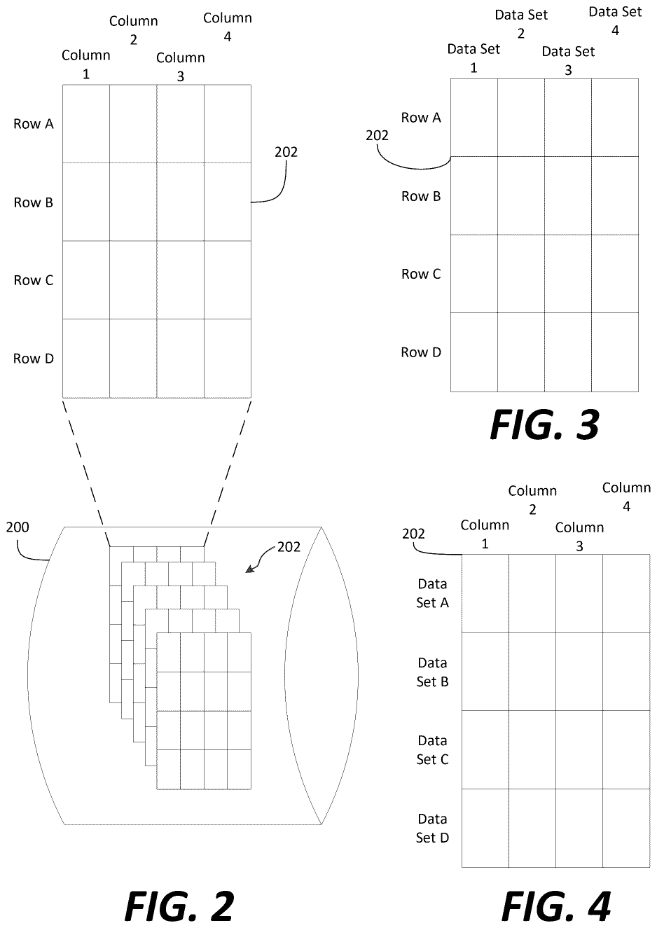

As noted above, the data sampling system 102 may sample one or more data sets from one or more data stores 104. FIGS. 2, 3, and 4 are a block diagram views of an example storage scheme for a data store, illustrating an example relationship between a database 200, data tables 202, and data sets. Referring to FIG. 2, a data store, such as a database 200, may include a plurality of data tables 202. Each data table 202 may include a plurality of rows (e.g., Rows A, B, C, D, . . . ) and a plurality of columns (e.g., Columns 1, 2, 3, 4, . . . ). As shown in FIG. 3, each column may be a data set for the purposes of sampling and analysis. As shown in FIG. 4, each row may be a data set for the purposes of sampling and analysis. Accordingly, analysis directed to a plurality of data sets may be directed to a plurality of rows within a given table 202, a plurality of columns within a given table 202, and/or multiple tables from one or more data stores 200.

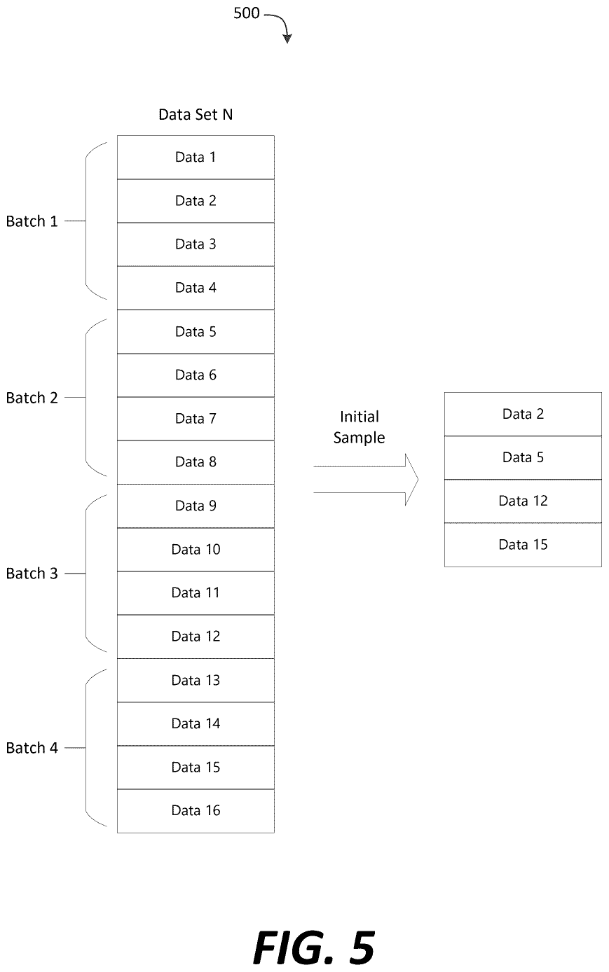

FIG. 5 is a flow chart illustrating an example method 500 of batching a data set and sampling from multiple batches. In the example, of FIG. 5, a Data Set N is illustrated comprising 16 data items. In this example, batching Data Set N may include dividing the data set into four equal batches of four data items apiece. Data Set N may be a row of a data table or a column of a data table, in some embodiments.

In some embodiments, the batches (1, 2, 3, and 4) may be sampled collectively. For example, as shown in FIG. 5, sampling batches 1-4 may include taking an equal quantity of data items from each batch. In the illustrated embodiment, one data item is sampled from each batch. The sampled data items my be selected at random from a batch, in some embodiments, and as shown in FIG. 5. Alternatively, samples may be selected according to a predetermined pattern within the batch (e.g., the tenth, twentieth, and so on data items within a batch, or another pattern). The sampled data may be used to calculate a target data score respective of the sample for the entire Data Set N, in some embodiments.

As indicated by the label “initial sample”, in some embodiments, the sampling process illustrated in FIG. 5 may be employed as an initial sampling step in a dynamic sampling process. Later sampling steps may include a different sampling strategy, as described below.

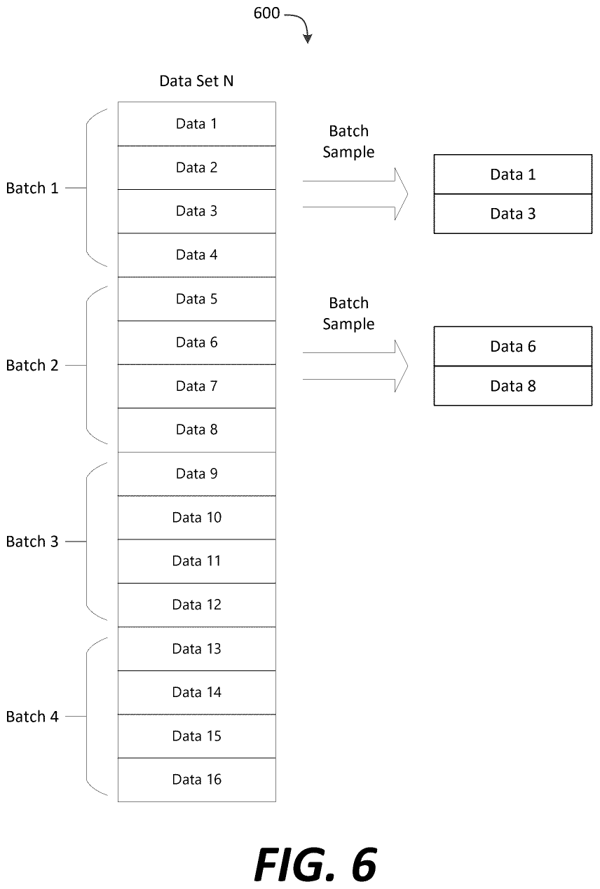

In some embodiments, batches may be sampled individually. For example, FIG. 6 is a flow chart illustrating an example method 600 of batching a data set and sampling from individual batches. The sampling strategy of FIG. 6 may be employed for sampling steps that occur after an initial sampling, such as an initial sampling according to FIG. 5.

In the example of FIG. 6, samples are taken from Batch 1, and separate samples are taken from Batch 2, and so on. In some embodiments, single-batch sampling may include sampling from only a subset of the batches within a data set, as shown in FIG. 6. Alternatively, single-batch sampling may include sampling from each batch within the data set. Where single-batch sampling is employed, a respective target information score may be calculated for each batch.

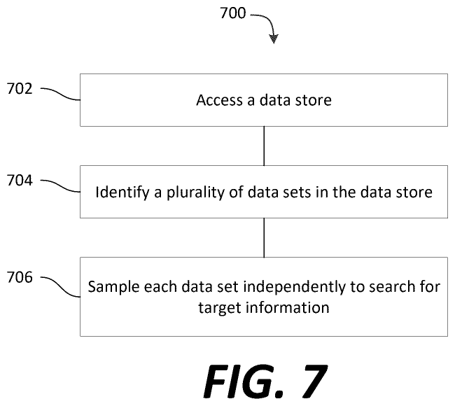

FIG. 7 is a flow chart illustrating an example method 700 of sampling data within a data store. The method 700, or one or more portions of the method 700, may be performed by the data sampling system 102, and thus the method 700 may be computer-implemented.

The method 700 may include, at operation 702, accessing a data store. The data store may be or may include a database, or multiple databases. The one or more databases may be databases associated with a computing system through which a data search or retrieval request was submitted and received. The data store to be accessed may be determined according to the subject matter of the search or retrieval request, in some embodiments.

The method 700 may further include, at operation 704, identifying a plurality of data sets in the data store. The data store may store a plurality of data sets, such as a plurality of tables, each having a plurality of rows and a plurality of columns, with each row or column being a respective data set. Accordingly, operation 704 may include identifying a plurality of data tables of a database and, for each data table, dividing the table by rows or columns. In some embodiments, identifying the plurality of data sets may be according to a storage format of one or more portions of the data store. For example, where the data store is a noSQL database, identifying data sets may include designating portions of a document as respective data sets, defining respective graphs in a graph storage as respective data sets, etc.

The method 700 may include, at operation 706, sampling each data set independently to search for target information. Where operation 704 results in identification of one hundred data sets, operation 706 may include conducting one hundred independent sampling processes to search the one hundred data sets for target information. An example method for sampling a single data set for target information is provided below with respect to FIG. 8.

FIG. 8 is a flow chart illustrating an example method of dynamic sampling of a large data set. The method 800, or one or more portions of the method 800, may be performed by the data sampling system 102, and thus the method 800 may be computer-implemented.

The method 800 may include, at operation 802, defining a plurality of batches of the large data set. For example, the large data set may be a column of a data table, and each batch may include a set of cells of the column. In some embodiments, a batch may include a contiguous set (e.g., range) of cells. A contiguous range of cells may be a set in which the indices of the cells increment with respect to one another (e.g., indices 58, 59, 60, 61, etc.). In some embodiments, the batches may be non-overlapping with respect to one another. In some embodiments, the batches may be of a substantially uniform size.

The method 800 may include, at operation 804, performing an initial sampling from all of the defined batches. The initial sampling may include sampling a uniform quantity of data points from each of the batches, where the sampled data points define an initial data sample. Sampled data points from each batch may be randomly selected, in some embodiments. Alternatively, sampled data points may be selected according to a predetermined pattern. In some embodiments, a combination of random and patterned sampling may be used.

The method 800 may include, at operation 806, examining the initial sample for target information. Examining sampled data for target information may include, for example, comparing each data item in the sample to a set of parameters defined for the target information. The parameters may include, in some embodiments, one or more format parameters and/or one or more content parameters. For example, where data from a certain date range is sought, the parameters may include the possible formats of a date, and the beginning and end dates of the range. In another example, where personally-identifiable information is sought, the parameters may include data formatted like a social security number, address, driver's license number, or other direct personal identifier, or data formatted like a date of birth, place of birth, IP address, biometric data, or other indirect identifier that is stored in conjunction with a name or other direct identifier. In some embodiments, examining sampled data may include determining a class of each identified item of target information and associating a respective class label with each such identified data point.

The method 800 may include, at operation 808, calculating an initial target information score. The initial target information score may be based on the examining of the initial data sample and may be indicative of a degree of presence of target information included in the initial data sample. The degree of presence may include, for example, a quantity of instances of target information included in the initial data sample and one or more (e.g., a plurality of) classes of target information included in the initial data sample. Calculating the initial target information score may include application of equations (1)-(3) as described above. The initial target information score may be respective of the entire data set because it may be based on samples taken from all batches of the data set, in some embodiments.

Operation 808 may include, in some embodiments, extracting, labelling, tagging, or otherwise identifying data items (e.g., cells) that contain target information for further processing, as described at the end of the method 800.

The method 800 may include, at operation 810, determining whether the initial target information score is above a threshold. If the initial target information score is below the threshold, then the method may end, as the data set does not include enough target information to warrant further review or processing. If the initial target information score is above the threshold, the method may advance to iterative sampling and examination of individual batches.

In some embodiments, operation 810 may include assigning a rank to the data set based on the initial target information score relative to the threshold. For example, a rank from a three-tier ranking set may be assigned; a rank of “1” may be assigned if the calculated score is above the threshold, and a rank of “3” may be assigned if the calculated score is below the threshold. In some embodiments, two thresholds may be used for comparison, with a rank of “3” assigned when the calculated score is below the lower threshold, “2” when the calculated score is between the thresholds, and “1” when the calculated score is above the higher threshold. In some embodiments, the rank may itself be considered a score for purposes of further analysis.

The method 800 may include, at operation 812, when the target information score is above the threshold, selecting a batch of the defined batches for further processing in operations 814, 816, 818.

The method 800 may include, at operation 814, sampling from the selected batch to define a further data sample (which may also be referred to as a batch data sample). Sampling at operation 814 may be from a single batch, unlike sampling at operation 804, which is from a plurality of batches. At operation 814, sampling may include sampling data items (e.g., cells) from within the batch at random. Additionally or alternatively, data items may be sampled according to a predetermined pattern.

In some embodiments, operation 814 may include excluding data items that were previously sampled in the method 800. For example, if a random sampling returns a previously-sampled data item, that data item may be omitted and a replacement data item may be selected (e.g., again at random or according to a predetermined pattern). In other embodiments, duplicate sampling may be permitted at operation 814.

The method 800 may include, at operation 816, examining the batch sample for target information. Examining the batch sample at operation 816 may be substantially as described above with respect to operation 806.

In some embodiments, operation 816 may include tracking (e.g., recording) a quantity of target information entries that have been identified in each class over the course of the performance of the method 800—that is, the quantity of target information of a particular class identified for a data set.

The method 800 may include, at operation 818, recalculating a target information score. The target information score may be calculated in the same way that the initial target information score was calculated, in some embodiments. Alternatively, recalculating the target information score may include calculating a raw score based on the quantity of instances and one or more (e.g., a plurality of) classes included in the batch (e.g., applying equations (1), (2), and (3)) and adjusting the prior (e.g., initial) target information score based on the raw score. For example, the prior target information score may be incremented or decremented based on the raw score. Where the raw score is lower than the prior target information score, the prior target information score may be decremented by a predetermined amount. Where the raw score is higher than the prior target information score, the prior target information score may be incremented by a predetermined amount. In some embodiments, either a calculated target information score may be incremented or decremented, or a rank (e.g., from a three-tier ranking arrangement) may be treated as a score and incremented or decremented.

In some embodiments, recalculating the target information score may include applying a set of class-specific weights to the respective classes of the examined instances of the target information. For example, as noted above with respect to equation (2), a plurality of different classes of target information may be assigned weights, and a highest-weight class of target information found in the batch sample may be considered for the class-based portion of the raw score, in some embodiments. Alternatively, both an existence and a quantity of one or more classes of target information may be included in the class-based score, such that five items of a given class results in a higher class score than a single item from that class.

In another example of calculating a raw score and adjusting the prior (e.g., initial) target information score based on the raw score, the class-specific weights may be altered based on the overall quantity of target information identified over the course of the method 800. For example, weights for duplicate classes (that is, classes that have factored in prior target information score calculations) may be reduced with each successive inclusion of the class in a target information score calculation. Referring to Table 1 above, if a weight of 100 is applied for Class 1 data the first time it is included in a target information score calculation, the weight may be decremented for each subsequent use in calculation, or for every two, or every five, proceeding times. For example, the second time Class 1 data is included in a target information score calculation, a weight of 90 may be applied. The third time, a weight of 80 may be applied. And so on.

The method 800 may further include returning to operation 810 and determining if the recalculated target information score is above the threshold. If the recalculated target information score remains above the threshold, the method may include again performing operations 812, 814, 816, 818, such that batches are iteratively batched and examined and iterations continue until the target information score falls below the threshold. When the recalculated target information score is below the threshold (e.g., after iteratively individually examining the data samples of the batches), the method may advance to operation 820 to take action on the large data.

The method 800 may further include, at operation 820, taking action (e.g., automatically) on the data set based on the identified target information. In some embodiments, the action taken at operation 820 may depend on the source of the search or retrieval request and the type of target information. For example, operation 820 may include altering the data set. For example, where the target information is PII, operation 820 may include deleting directly identifiable PII or another class of target information, anonymizing certain PII or another class of target information, and/or encrypting certain PII or another class of target information. Additionally or alternatively, the action taken at operation 820 may include notifying one or more end users of the storage of target information. For example, operation 820 may include notifying one or more users that their PII is stored and prompting the users for instructions on further handling of the PII. In some embodiments, the action taken at operation 820 may be based on the one or more classes assigned to the identified items of target information. For example, certain classes of identified data may be deleted, other classes may be anonymized, others may be maintained, etc. In another example, some classes may be collected and returned to the requesting user, whereas others may be summarized for the user, and so on.

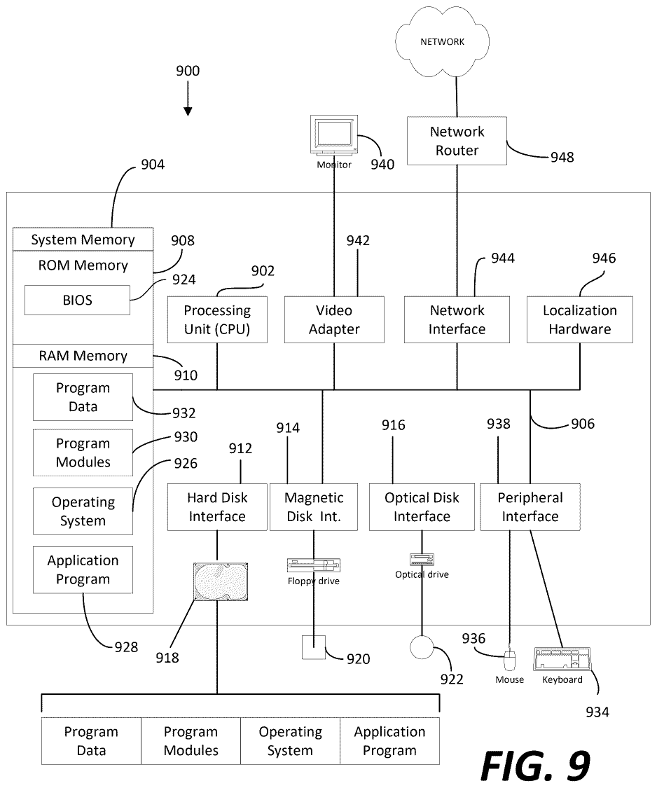

FIG. 9 is a block diagram of an example computing system 900, such as a desktop computer, laptop, smartphone, tablet, or any other such device having the ability to execute instructions, such as those stored within a non-transient, computer-readable medium. Furthermore, while described and illustrated in the context of a single computing system 900, those skilled in the art will also appreciate that the various tasks described hereinafter may be practiced in a distributed environment having multiple computing systems 900 linked via a local or wide-area network in which the executable instructions may be associated with and/or executed by one or more of multiple computing systems 900.

In its most basic configuration, computing system environment 900 typically includes at least one processing unit 902 and at least one memory 904, which may be linked via a bus 906. Depending on the exact configuration and type of computing system environment, memory 904 may be volatile (such as RAM 910), non-volatile (such as ROM 908, flash memory, etc.) or some combination of the two. Computing system environment 900 may have additional features and/or functionality. For example, computing system environment 900 may also include additional storage (removable and/or non-removable) including, but not limited to, magnetic or optical disks, tape drives and/or flash drives. Such additional memory devices may be made accessible to the computing system environment 900 by means of, for example, a hard disk drive interface 912, a magnetic disk drive interface 914, and/or an optical disk drive interface 916. As will be understood, these devices, which would be linked to the system bus 906, respectively, allow for reading from and writing to a hard disk 918, reading from or writing to a removable magnetic disk 920, and/or for reading from or writing to a removable optical disk 922, such as a CD/DVD ROM or other optical media. The drive interfaces and their associated computer-readable media allow for the nonvolatile storage of computer readable instructions, data structures, program modules and other data for the computing system environment 900. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 900.

A number of program modules may be stored in one or more of the memory/media devices. For example, a basic input/output system (BIOS) 924, containing the basic routines that help to transfer information between elements within the computing system environment 900, such as during start-up, may be stored in ROM 908. Similarly, RAM 910, hard drive 918, and/or peripheral memory devices may be used to store computer executable instructions comprising an operating system 926, one or more applications programs 928, other program modules 930, and/or program data 932. The program modules 930 may include, for example, one or more of the functional modules 116, 118, 120, 122.

An end-user may enter commands and information into the computing system environment 900 through input devices such as a keyboard 934 and/or a pointing device 936. While not illustrated, other input devices may include a microphone, a joystick, a game pad, a scanner, etc. These and other input devices would typically be connected to the processing unit 902 by means of a peripheral interface 938 which, in turn, would be coupled to bus 906. Input devices may be directly or indirectly connected to processor 902 via interfaces such as, for example, a parallel port, game port, firewire, or a universal serial bus (USB). To view information from the computing system environment 900, a monitor 940 or other type of display device may also be connected to bus 906 via an interface, such as via video adapter 942. In addition to the monitor 940, the computing system environment 900 may also include other peripheral output devices, not shown, such as speakers and printers.

The computing system environment 900 may also utilize logical connections to one or more computing system environments. Communications between the computing system environment 900 and the remote computing system environment may be exchanged via a further processing device, such a network router 948, that is responsible for network routing. Communications with the network router 948 may be performed via a network interface component 944. Thus, within such a networked environment, e.g., the Internet, World Wide Web, LAN, or other like type of wired or wireless network, it will be appreciated that program modules depicted relative to the computing system environment 900, or portions thereof, may be stored in the memory storage device(s) of the computing system environment 900.

The computing system environment 900 may also include localization hardware 946 for determining a location of the computing system environment 900. In embodiments, the localization hardware 946 may include, for example only, a GPS antenna, an RFID chip or reader, a WiFi antenna, or other computing hardware that may be used to capture or transmit signals that may be used to determine the location of the computing system environment 900.

The computing system 900, or one or more portions thereof, may embody a data sampling system 102, developer computing system 106, computing action processing system 108, user computing device 110, and/or another system, in some embodiments.

In a first aspect of the present disclosure, a computer-implemented method for sampling a large data set to identify target information is provided. The method includes defining a plurality of batches of the large data set, sampling a uniform quantity of data points from each of the batches in a first sampling iteration, wherein the sampled data points define an initial data sample, examining the initial data sample for the target information, calculating an initial target information score based on the examining of the initial data sample, the initial target information score indicative of a degree of presence of target information included in the initial data sample, and iteratively individually examining the batches by selecting a batch from the plurality of batches, sampling a quantity of data points from the selected batch to define a further data sample, examining the further data sample for the target information, calculating a further target information score based on the examining of the further data sample, the further target information score indicative of a degree of presence of target information in the further data sample, and continuing the iterations until the further target information score is below a threshold.

In an embodiment of the first aspect, iteratively examining the batches further includes recording a number of times a class of target information has been examined in the method, wherein the target information is of a plurality of different classes, wherein the further target information score is based on and indicative of the number of times the class of target information has been examined.

In an embodiment of the first aspect, the target information is of a plurality of different classes, and the method further includes, after iteratively individually examining the batches, taking action on the large data set according to each class of target information found in the data set. In a further embodiment of the first aspect, taking action on the large data set includes deleting each instance of at least one of the classes of target information from the large data set.

In an embodiment of the first aspect, the target information is personally identifiable information.

In an embodiment of the first aspect, the target information includes multiple ranked classes of information, the initial target information score is based on a highest class of target data included in the initial data sample, and the further target information score is based on a highest class of target data included in the further data sample.

In an embodiment of the first aspect, calculating the further target information score is based on the initial target information score.

In an embodiment of the first aspect, the large data set includes a column of a data table, and each batch includes a set of cells of the column.

In an embodiment of the first aspect, the batches are non-overlapping.

In a second aspect of the present disclosure, a computer-implemented method for sampling a large data set to identify target information is provided. The method includes defining a plurality of batches of the large data set, iteratively individually examining the batches by selecting a batch from the plurality of batches, sampling a quantity of data points from the selected batch to define a batch data sample, examining the batch data sample for instances of the target information, calculating a target information score based on the examining of the batch data sample, the target information score indicative of a quantity of instances of target information included in the data sample and one or more classes of target information included in the data sample, and continuing the iterations until the target information score is below a threshold, and altering the data set according to the one or more classes of target information included in the data samples of the batches.

In an embodiment of the second aspect, the method further includes, before iteratively examining the batches, sampling a uniform quantity of data points from each of the batches in a first sampling iteration, wherein the sampled data points define an initial data sample, examining the initial data sample for instances of the target information, and calculating an initial target information score based on the examining of the initial data sample, the initial target information score indicative of a quantity of instances of target information included in the initial data sample and one or more classes of target information included in the initial data sample, wherein the target information score is further based on the initial target information score.

In an embodiment of the second aspect, the large data set includes a column of a data table, and each batch includes a set of cells of the column.

In an embodiment of the second aspect, the batches are of a substantially uniform size.

In an embodiment of the second aspect, calculating the target information score includes applying a set of class-specific weights to the respective classes of the examined instances of the target information.

In an embodiment of the second aspect, calculating the target information score includes calculating a raw score based on the quantity of instances and one or more classes included in the batch, and adjusting the target information score from a previous iteration based on the raw score.

In an embodiment of the second aspect, altering the data set includes deleting each instance of a first class of target information from the large data set, encrypting each instance of a second class of target information from the large data set, and anonymizing each instance of a third class of target information from the large data set.

In a third aspect of the present disclosure, a computer-implemented method for sampling a large data set to identify target information is provided. The method includes identifying a plurality of data tables of a database and, for each data table, dividing the table by rows or columns and, for each row or column, defining a plurality of non-overlapping batches, each batch including a plurality of cells of the row or column, iteratively individually examining the batches by selecting a batch from the plurality of batches, sampling a quantity of data points from the selected batch to define a batch data sample, examining the batch data sample for instances of the target information, calculating a target information score based on the examining of the batch data sample, the target information score indicative of a degree of presence of target information included in the data sample, and continuing the iterations until the target information score is below a threshold.

In an embodiment of the third aspect, identifying the plurality of data tables of the database includes identifying a respective plurality of data tables of a plurality of databases.

In an embodiment of the third aspect, the method further includes, before iteratively examining the batches, sampling a uniform quantity of data points from each of the batches in a first sampling iteration, wherein the sampled data points define an initial data sample, examining the initial data sample for instances of the target information, and calculating an initial target information score based on the examining of the initial data sample, the initial target information score indicative of a quantity of instances of target information included in the initial data sample and one or more classes of target information included in the initial data sample, wherein the target information score is further based on the initial target information score.

In an embodiment of the third aspect, each batch includes a respective contiguous range of cells.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method for sampling a large data set to identify target information, the method comprising:
defining a plurality of batches of the large data set;
sampling a uniform quantity of data points from each of the batches in a first sampling iteration, wherein the sampled data points define an initial data sample;
examining the initial data sample for the target information;
calculating an initial target information score based on the examining of the initial data sample, the initial target information score indicative of a degree of presence of target information included in the initial data sample; and
iteratively individually examining the batches by:
selecting a batch from the plurality of batches;
sampling a quantity of data points from the selected batch to define a further data sample;
examining the further data sample for the target information;
calculating a further target information score based on the examining of the further data sample, the further target information score indicative of a degree of presence of target information in the further data sample; and
continuing the iterations until the further target information score is below a threshold.

2. The computer-implemented method of claim 1, wherein iteratively examining the batches further comprises:
recording a number of times a class of target information has been examined in the method, wherein the target information is of a plurality of different classes;
wherein the further target information score is based on and indicative of the number of times the class of target information has been examined.

3. The computer-implemented method of claim 1, wherein:
the target information is of a plurality of different classes; and
the method further comprises, after iteratively individually examining the batches, taking action on the large data set according to each class of target information found in the data set.

4. The computer-implemented method of claim 3, wherein taking action on the large data set comprises deleting each instance of at least one of the classes of target information from the large data set.

5. The computer-implemented method of claim 1, wherein the target information is personally identifiable information.

6. The computer-implemented method of claim 1, wherein:
the target information comprises multiple ranked classes of information;
the initial target information score is based on a highest class of target data included in the initial data sample; and
the further target information score is based on a highest class of target data included in the further data sample.

7. The computer-implemented method of claim 1, wherein calculating the further target information score is based on the initial target information score.

8. The computer-implemented method of claim 1, wherein:
the large data set comprises a column of a data table; and
each batch comprises a set of cells of the column.

9. The computer-implemented method of claim 1, wherein the batches are non-overlapping.

10. A computer-implemented method for sampling a large data set to identify target information, the method comprising:
defining a plurality of batches of the large data set;
iteratively individually examining the batches by:
selecting a batch from the plurality of batches;
sampling a quantity of data points from the selected batch to define a batch data sample;
examining the batch data sample for instances of the target information;
calculating a target information score based on the examining of the batch data sample, the target information score indicative of a quantity of instances of target information included in the data sample and one or more classes of target information included in the data sample; and
continuing the iterations until the target information score is below a threshold; and
altering the data set according to the one or more classes of target information included in the data samples of the batches.

11. The computer-implemented method of claim 10, further comprising, before iteratively examining the batches:
sampling a uniform quantity of data points from each of the batches in a first sampling iteration, wherein the sampled data points define an initial data sample;
examining the initial data sample for instances of the target information; and
calculating an initial target information score based on the examining of the initial data sample, the initial target information score indicative of a quantity of instances of target information included in the initial data sample and one or more classes of target information included in the initial data sample;
wherein the target information score is further based on the initial target information score.

12. The computer-implemented method of claim 10, wherein:
the large data set comprises a column of a data table; and
each batch comprises a set of cells of the column.

13. The computer-implemented method of claim 10, wherein the batches are of a substantially uniform size.

14. The computer-implemented method of claim 10, wherein calculating the target information score comprises applying a set of class-specific weights to the respective classes of the examined instances of the target information.

15. The computer-implemented method of claim 10, wherein calculating the target information score comprises:
calculating a raw score based on the quantity of instances and one or more classes included in the batch; and
adjusting the target information score from a previous iteration based on the raw score.

16. The computer-implemented method of claim 10, wherein altering the data set comprises:
deleting each instance of a first class of target information from the large data set;
encrypting each instance of a second class of target information from the large data set; and
anonymizing each instance of a third class of target information from the large data set.

17. A computer-implemented method for sampling a large data set to identify target information, the method comprising:
identifying a plurality of data tables of a database and, for each data table:
dividing the table by rows or columns and, for each row or column:
defining a plurality of non-overlapping batches, each batch comprising a plurality of cells of the row or column;
iteratively individually examining the batches by:
selecting a batch from the plurality of batches;
sampling a quantity of data points from the selected batch to define a batch data sample;
examining the batch data sample for instances of the target information;
calculating a target information score based on the examining of the batch data sample, the target information score indicative of a degree of presence of target information included in the data sample; and
continuing the iterations until the target information score is below a threshold.

18. The computer-implemented method of claim 17, wherein identifying the plurality of data tables of the database comprises identifying a respective plurality of data tables of a plurality of databases.

19. The computer-implemented method of claim 17, further comprising, before iteratively examining the batches:
sampling a uniform quantity of data points from each of the batches in a first sampling iteration, wherein the sampled data points define an initial data sample;
examining the initial data sample for instances of the target information; and
calculating an initial target information score based on the examining of the initial data sample, the initial target information score indicative of a quantity of instances of target information included in the initial data sample and one or more classes of target information included in the initial data sample;
wherein the target information score is further based on the initial target information score.

20. The computer-implemented method of claim 17, wherein each batch comprises a respective contiguous range of cells.
